(19) United States
(12) Patent Application Publication
(10) Pub. No.: US 2010/0256911 A1
(43) Pub. Date: Oct. 7, 2010

(54) Indicating device capable of detecting environmental conditions

(76) Inventor: C. W. Yes, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/896,464

(22) Filed: Aug. 31, 2007

(51) Int. Cl. G06F 19/00

(52) U.S. Cl. 702/2

(57) ABSTRACT

An indicating device capable of detecting environmental conditions includes a detection module, a selector, a functional processing unit, a display, and a power supply. The detection module detects UV light strength, temperature, moisture, and pressure. The selector selects the required detection information and sends it to the functional processing unit for signal processing. The result is shown on the display. The invention can be applied to a compact electronic watch for displaying both time and multiple environmental conditions simultaneously and for user's convenience of carrying.

### BACKGROUND OF THE INVENTION

1. Field of Invention

The invention relates to an indicating device capable of detecting environmental conditions and, in particular, to an indicating device with multiple detection functions.

2. Related Art

FIG. 3 shows the system structure of a conventional indicating device for detecting the environment. It is usually made into an electronic watch for the user to carry along. The system 9 mainly includes an electronic watch core 91 and a functional processor 92 connected together. The functional processor 92 is further connected with a photo detector 93, a power supply 94, and an LED display 95.

In its normal state, the display 95 shows the current time given by the electronic watch core 91. The photo detector 93 detects the ultraviolet (UV) light strength in the environment. Such information is sent to the functional processor 92 for signal processing. The result is then shown to the user.

However, the above-mentioned system cannot detect multiple environmental conditions. Therefore, its applications are limited. Moreover, the electronic watch core and the functional processor are separated. This increases the required space and cost.

### SUMMARY OF THE INVENTION

An objective of the invention is to solve the above-mentioned problems and provides an indicating device capable of detecting environmental conditions. By providing a detection module having various detectors, the invention can detect the UV light strength, temperature, moisture, and pressure in the surroundings. Such information is provided to the user for his/her references.

Another objective of the invention is to provide a detection module having multiple detectors inside an electronic watch, such that it can indicate both time and environmental conditions. Thus, the invention provides an indicating device that is portable.

Yet another objective of the invention is to integrate the time function into the functional processor for the purpose of saving space and cost.

To achieve the above-mentioned objectives, the invention comprises: a detection module for detecting environmental conditions, a selector, a functional processing unit, a display, and a power supply for supplying the power required by the above-mentioned components.

The detection module includes at least a photo detector, a temperature detector, a moisture detector, and a pressure detector. Each of the detectors detects one environmental condition and generates an analog signal.

The selector receives the analog signals from the detection module and selectively transmits the analog signal of one of the detectors in accord with the user's choice.

The functional processing unit is connected with the selector and includes at least an analog-to-digital (A/D) converter and a central processor for converting the analog signal from the selector to a digital signal. The digital signal is then processed into a displaying signal.

The display is connected with the functional processing unit for showing the displaying signal thereof.

### BRIEF DESCRIPTION OF THE DRAWINGS

The invention will become more fully understood from the detailed description given herein below illustration only, and thus is not limitative of the present invention, and wherein:

FIG. 1 is a system block diagram of the disclosed indicating device;

FIG. 2 shows the appearance of the disclosed indicating device used on an electronic watch; and

FIG. 3 is the system block diagram of a conventional detecting device.

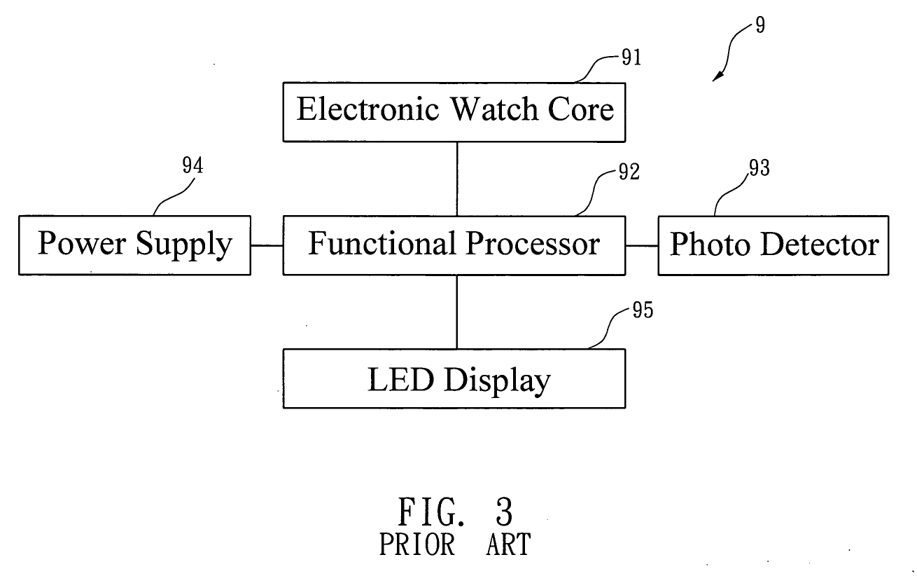

### DETAILED DESCRIPTION OF THE INVENTION

The present invention will be apparent from the following detailed description, which proceeds with reference to the accompanying drawings, wherein the same references relate to the same elements.

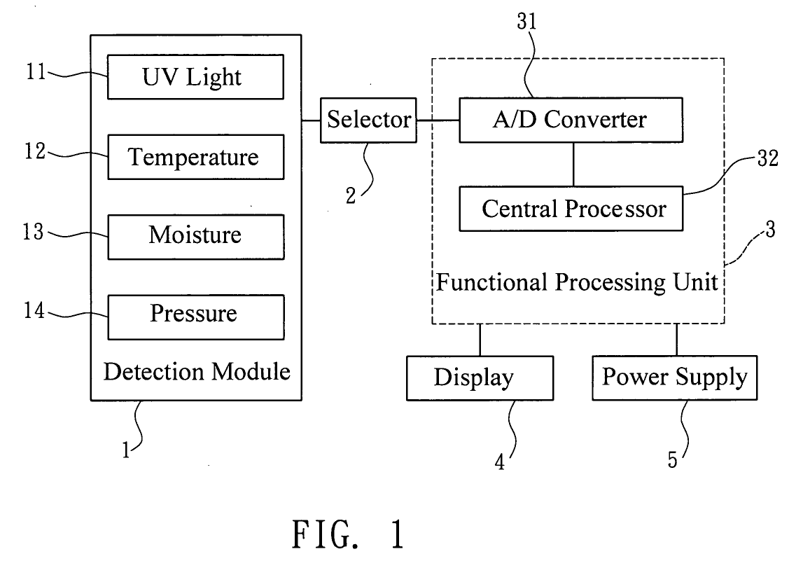

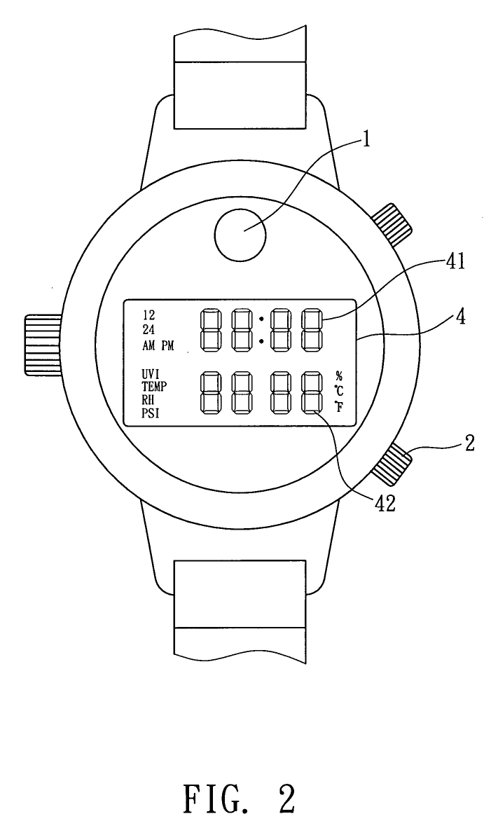

A preferred embodiment of the invention is illustrated in FIGS. 1 and 2. The preferred embodiment is disclosed for the purpose of explaining the basic ideas of the invention, and should not be used to restrict the scope defined in the claims.

The indicating device capable of detecting environmental conditions according to the invention includes a detection module 1, a selector 2, a functional processing unit 3, a display 4, and a power supply 5.

The detection module 1 includes at least a photo detector 11, a temperature detector 12, a moisture detector 13, and a pressure detector 14. Each of the detectors can detect one environmental condition of the surroundings and generates an analog signal. The photo detector is used to detect UV light strength in the environment.

The selector 2 is electrically connected with the detection module 1 for receiving the analog signals detected by the detectors thereof. The user can select to transmit one of the analog signals.

The functional processing unit 3 is connected with the selector 2. It includes at least an A/D converter 31 and a central processor 32. The A/D converter 31 converts the analog signal from the selector 2 into a digital signal. The digital signal is then processed by the central processor 32 into a displaying signal. The functional processing unit 3 further computes and record time, and can generate a signal of time.

The display 4 receives the signal from the functional processor 3, and shows the displaying signal transmitted from the functional processor. The power supply 5 supplies the power required by the above-mentioned components 1, 2, 3, 4.

In this embodiment, the indicating device is disposed in an electronic watch, as shown in FIG. 2. The display of the indicating device is the display 4 of the electronic watch. The display 4 includes at least a time displaying area 41 for displaying time and an environmental condition displaying area 42 for showing information of the environment as detected by the detectors.

In practice, the user adjusts the selector 2 to choose one environmental condition to detect. Afterwards, the detection module 1 detects the corresponding environmental condition, and generates and transmits an analog signal to the functional processing unit 3. The analog signal is converted into a displaying signal, which is then transmitted to the environmental condition displaying area 42. The detected value of the environmental condition is thus provided to the user.

In summary, by integrating the time displaying function into a functional processor, the invention can avoid the use of an electronic watch core. This saves the required space and cost. Besides, the electronic watch having a detection module with multiple detectors can display time as well as information of the environmental conditions with the advantage of great portability.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An indicating device capable of detecting environmental conditions, comprising:
a detection module, which detects environmental conditions of its surroundings and includes at least a photo detector, a temperature detector, a moisture detector, and a pressure detector, wherein each of the detectors detects one environmental condition and generates an analog signal;
a selector, which receives the analog signals from the detection module and selectively transmits one of the analog signals;
a functional processing unit, which is connected with the selector and includes at least an analog-to-digital converter and a central processor for converting the analog signal transmitted from the selector into a digital signal, the digital signal being further processed into an displaying signal;
a display, which is connected with the functional processing unit for displaying the displaying signal thereof; and
a power supply, which supplies the power required by the above-mentioned components.

2. An indicating device capable of detecting environmental conditions as in claim 1, wherein the display includes at least a time displaying area and an environmental condition displaying area.

3. An indicating device capable of detecting environmental conditions as in claim 2, wherein the time displaying area displays time and the environmental condition displaying area displays the value detected by one of the detectors.

4. An indicating device capable of detecting environmental conditions as in claim 1, wherein the photo detector detects UV light strength.
